(19) United States
(12) Patent Application Publication
(10) Pub. No.: US 2007/0072600 A1
(43) Pub. Date: Mar. 29, 2007

(54) Method and system for reporting link state in a communication system

(75) Inventors: Jae-Weon Cho, Suwon-si (KR); Hyun-Jeong Kang, Seoul (KR); Pan-Yuh Joo, Seoul (KR); Jung-Je Son, Seongnam-si (KR); Hyoung-Kyu Lim, Seoul (KR); Sung-Jin Lee, Suwon-si (KR); Mi-Hyun Lee, Seoul (KR); Yeong-Moon Son, Anyang-si (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/477,303

(22) Filed: Jun. 29, 2006

(30) Foreign Application Priority Data
Jun. 29, 2005 (KR) 56903/2005

(51) Int. Cl. H04Q 7/20

(52) U.S. Cl. 455/423

(57) ABSTRACT

Disclosed is a method and system for link state report in order to select an optimum route in a wireless communication system which includes a mobile station, a base station for providing a service to the mobile station, and one or more relay stations for relaying information between the base station and the mobile station. The method includes: detecting a physical channel from the base station and measuring a link state of a link with the base station based on the detected physical channel, and inserting information of the measured link state into a message and broadcasting the message through a wireless channel.

### PRIORITY

This application claims the benefit under 35 U.S.C. §119(a) of an application entitled “Method And System For Reporting Link State In A Communication System” filed in the Korean Industrial Property Office on Jun. 29, 2005 and assigned Ser. No. 2005-56903the contents of which are incorporated herein by reference.

### BACKGROUND OF THE INVENTION

1. Field of the Invention

The present invention relates to a communication system, and more particularly to a method and a system for reporting a link state in a communication system using a multi-hop relay scheme.

2. Description of the Related Art

Portable electronic devices, such as notebook computers, cellular phones, Personal Digital Assistants (PDAs) and Moving Picture Expert Group (MPEG) 3 (MP3) devices, are widely used in today's population. Most of such devices independently operate without inter-working with each other. In a wireless network constructed only by the portable electronic devices without the aid of a central control system, the portable electronic devices can share various information and can thus provide various services to users. Such a wireless network, in which portable electronic devices can communicate with each other without aid of a central control system as described above, is called an ad hoc network or a ubiquitous network. The ad hoc network was derived for military purposes in the 1970's and has been used in such areas as battlefields and disaster areas.

Active research for next generation communication systems is being conducted in order to provide users with services of various Qualities of Service (QoSs) with large capacities at a high transmission speed. In order to achieve such a next generation communication system which can provide high speed communication service and can handle a large quantity of traffic, it is necessary to install therein cells having a very small cell range. However, it may be impossible to realize the next generation communication system including cells having a very small cell range, by using the current wireless network design scheme, which is for a centralized network. That is, the next generation communication system requires a wireless network design scheme, which can construct the system to be controllable in a distributed scheme and can actively cope with environmental changes, such as the addition of a new Base Station (BS). Therefore, the next generation communication system requires construction of a self-configurable wireless network. The self-configurable wireless network is constructed in a distributed as well as self-controllable scheme without control of a central system, in order to provide a communication service.

Further, in order to realize the self-configurable wireless network in the next generation communication system, the scheme applied to the ad hoc network must be applied to the next generation communication system. A representative example of such an application is a cellular network using a multi-hop relay scheme, which is constructed by applying the multi-hop relay scheme employed in the ad hoc network to a cellular network system including a fixed BS. Because communication is performed through one direct link between a fixed BS and a Mobile Station (MS) in the cellular network, it is possible to easily construct a radio communication link having a high reliability between the MS and the BS. However, since the BS is fixed, there is a low flexibility in constructing the wireless network, and it is thus difficult to provide an effective communication service in a wireless environment which has a large change in the traffic distribution or required traffic quantity. In order to overcome such a problem, the cellular network may employ a relay scheme for transmitting data in the form of multi-hops by using a plurality of neighbor MSs or fixed Relay Stations (RSs). Then, the cellular network employing such a relay scheme can rapidly perform reconstruction of the network in response to the environmental change and can more efficiently operate the entire wireless network. Therefore, implementation of a self-configurable wireless network in the next generation communication system can be achieved by a cellular network using the multi-hop relay scheme.

The cellular network using the multi-hop relay scheme can broaden the cell service area and increase the system capacity. That is, when the channel state between the BS and the MS is in a poor condition, the cellular network can provide a wireless channel having an improved channel condition to the MS by constructing a multi-hop relay route through the RS for the MS. Therefore, in a shade area in which electric waves are shielded or reflected by buildings, for example, it is possible to more efficiently provide a communication service by using the multi-hop relay scheme. Further, in a cell boundary area which is far from a BS and is in a poor channel state, it is possible to provide a higher speed data channel and enlarge the cell service area, by using the multi-hop relay scheme.

In a cellular network using such a multi-hop relay scheme, one of the most important techniques is the routing technique. The routing technique is for selecting an optimum route from multiple hop routes provided between a BS and an MS. In the cellular network using the multi-hop relay scheme, because the BS controls all RSs and MSs located within the cell, the BS determines the optimum route. In contrast, in the ad hoc network which is constructed autonomously by all nodes themselves, each of the nodes determines its own optimum route by the aid of neighbor nodes. As described above, the body which selects the optimum route in the cellular network using the multi-hop relay scheme is different from that of the ad hoc network. Therefore, the routing technique of the ad hoc network cannot be applied as it is to the cellular network using the multi-hop relay scheme.

The routing technique in the cellular network using the multi-hop relay scheme can be briefly divided into three steps. Specifically, the routing technique includes the first step in which the MS recognizes a neighbor RS adjacent to the MS itself, the second step in which the MS reports the link state or quality between the MS and the cognized RS to the BS, and the third step in which the BS determines the optimum route (a route from the BS through the RS to the MS) based on the reported link state. In the first step, the RS transmits a control signal to the MS, in order to make the MS recognize the RS. Then, in the second step, the MS recognizes the link state between the RS and the MS by measuring a Received Signal Strength Indicator (RSSI) or a Signal to Interference and Noise Ratio (SINR) of a control signal from the RS, for example, a pilot preamble sequence, and reports the recognized link state to the BS. In the third step, the BS determines the optimum route and provides a communication service to the MS through the determined route.

Therefore, in the cellular network using the multi-hop relay scheme, it is possible to maximize the performance of the multi-hop relay cellular network only when the BS selects the exact optimum route. However, in order to select the optimum route for each MS, the BS must recognize all link states between the MS and all RSs around the MS. When a plurality of RSs are located around the MS, the MS may have too much link state information to report to the BS. Further, the link states may change when the MS is moving, and the MS must periodically report the link state information for the neighbor RSs to the BS. Moreover, in a system using a Mobile Relay Station (MRS), the link states may change more severely. Therefore, it is necessary to shorten the period at which the MS reports the link state information to the BS. Then, the quantity of uplink load between the MS and the BS for reporting the link state information between the MS and the RS is further increased.

However, there has yet to be proposed a routing technique which can select an optimum route while minimizing the quantity of message load in a cellular network using the multi-hop relay scheme. Particularly, although the routing algorithm for the ad hoc network has been researched to a considerable degree, it is impossible to apply the routing technique of the ad hoc network, as it is, to the cellular network using the multi-hop relay scheme, as described above. Therefore, there has been a request for a routing technique which can select an optimum route while minimizing the message load in a cellular network using the multi-hop relay scheme.

Hereinafter, a routing technique in a cellular network using the multi-hop relay scheme will be described.

FIGS. 1 and 2 illustrate structures of cellular networks using the multi-hop relay scheme.

Referring to FIG. 1, a first cellular network using the multi-hop relay scheme includes a fixed BS 110, an MS 120 controlled by the BS 110, and RS1 130 and RS2 140 for providing multi-hop relay routes to the MS 120. In the cellular network, in order to select an optimum route between the BS 110 and the MS 120, the MS 120 measures an SINR or RSSI of a preamble of the RS1 130 and the RS2 140 located adjacent to the MS 120, selects an RS having the highest value from among the measured values, and reports the link state information between the MS and the selected RS to the BS 110. It is assumed that the link 161 between the BS 110 and the MS 120 and the link 165 between the BS 110 and the RS2 140 have preambles with a considerably small RSSI or SINR due to shielding by a building, and the link 163 between the BS 110 and the RS1 130 has a preamble having a considerably large RSSI or SINR.

Further, the RS2 140 is nearer to the MS 120 than the RS1 130, and the RSSI or SINR of the RS2 140 is thus larger than the RSSI or SINR of the RS1 130. Meanwhile, because the RSSI or SINR of the link 165 between the BS and the RS2 is considerably small, the RSSI or SINR of the route of BS-RS1-MS 163 and 167 is larger than that of the route of BS-RS2-MS 165 and 169 in the entire route. However, because the RSSI or SINR of the RS2 140 is larger than the RSSI or SINR of the RS1 130, the MS 120 selects the RS2 140 as the optimum RS and reports the state information about the link 169 between the MS 120 and the selected RS2 140 to the BS 110. Then, the BS 110 selects the route of BS-RS2-MS 165 and 169 as the optimum route, in spite of the fact that the route of BS-RS 1-MS 163 and 167 is the optimum route.

Referring to FIG. 2, a second cellular network using the multi-hop relay scheme includes a fixed BS 210, an MS 220 controlled by the BS 210, and an RS 230 which provides a multi-hop relay route to the MS 220. In the cellular network, in order to select an optimum route between the BS 210 and the MS 220, the MS 220 measures an SINR or RSSI of a preamble of the RS 230 located adjacent to the MS 220, and reports the link state information between the MS 220 and the RS 230 to the BS 210.

The MS 220 is located nearer to the BS 210 than to the RS 230. Also, due to shielding by a building, the link 251 between the BS 210 and the RS 230 has a preamble having an RSSI or SINR smaller than the RSSI or SINR of the direct route 253 between the BS 210 and the MS 220 in the entire route 251˜255. Then, even when the MS 220 reports the information about th the BS 210, such a report is meaningless because the optimum route is the direct route 253 between the BS 210 and the MS 220. However, the MS 220 has no way of recognizing the link state 251 between the BS 210 and the RS 230 and thus has no information about the SINR or RSSI of the entire route 251˜255. Therefore, the MS 220 unconditionally reports the state information of the link 255 between the MS 220 and the RS 230 to the BS 210. Such an unconditional report corresponds to transmission of unnecessary information from the MS 220 to the BS 210, which increases the load in the message transmission.

Therefore, there is a need for a scheme for reporting link state information to a BS in a cellular network using the multi-hop relay scheme, which can achieve selection of an optimum route while minimizing the load in message transmission. Further, there is a need for a scheme for exact selection of an optimum route while minimizing the load in message transmission in a communication system.

### SUMMARY OF THE INVENTION

Accordingly, the present invention has been made to solve at least the above-mentioned problems occurring in the prior art, and an aspect of the present invention is to provide a method and system for link state report in order to select an optimum route in a communication system.

It is another aspect of the present invention to provide a method and system for link state report in order to select an optimum route, which can minimize the quantity of link state information in a communication system.

In order to accomplish these aspects, there is provided a method for reporting a link state by a relay station in a communication system which includes a mobile station, a base station for providing a service to the mobile station, and one or more relay stations for relaying information between the base station and the mobile station, the method including detecting a physical channel from the base station and measuring a link state of a link with the base station based on the detected physical channel, and inserting information of the measured link state into a message and broadcasting the message through a wireless channel.

In accordance with the present invention, there is provided a method for reporting a link state by a mobile station in a communication system which includes the mobile station, a base station for providing a service to the mobile station, and one or more relay stations for relaying information between the base station and the mobile station, the method including detecting physical channels from the base station and said one or more relay stations and measuring link states of the detected physical channels, and selecting a physical channel from the detected physical channels based on the measured link states and then broadcasting link state information of the selected physical channel.

In accordance with the present invention, there is provided a system for reporting a link state in a communication system which includes a mobile station, a base station for providing a service to the mobile station, and one or more relay stations for relaying information between the base station and the mobile station, the system including a transmitter for detecting a base station preamble from the base station and one or more relay station preambles from said one or more relay stations, measuring link states based on the detected preambles, selecting one preamble from the detected preambles based on the measured link states, and broadcasting the selected preamble, and a receiver for detecting the preamble from the transmitter, measuring a link state based on the detected preamble, and restoring information data transferred by the preamble.

In accordance with the present invention, there is provided a system for reporting a link state in a communication system which includes a mobile station, a base station for providing a service to the mobile station, and one or more relay stations for relaying information between the base station and the mobile station, the system including a relay station for detecting a physical channel from the base station, measuring a link state of a link with the base station based on the detected physical channel, inserting information of the measured link state into a message, and broadcasting the message including the information through a wireless channel.

In accordance with the present invention, there is provided a system for reporting a link state in a communication system which includes the mobile station, a base station for providing a service to the mobile station, and one or more relay stations for relaying between the base station and the mobile station, the system including the mobile station for detecting physical channels from the base station and said one or more relay stations, measuring link states of the detected physical channels, selecting a physical channel from the detected physical channels based on the measured link states, and then broadcasting link state information of the selected physical channel.

### BRIEF DESCRIPTION OF THE DRAWINGS

The above and other objects, features and advantages of the present invention will be more apparent from the following detailed description taken in conjunction with the accompanying drawings, in which:

FIG. 1 is a view for illustrating a structure of a first conventional communication system using a multi-hop relay scheme;

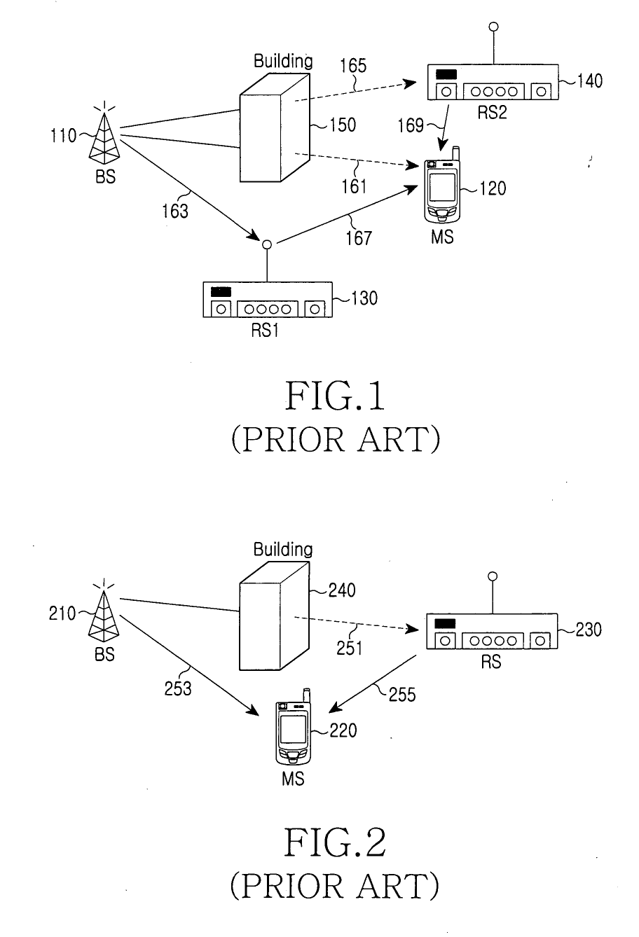

FIG. 2 is a view for illustrating a structure of a second conventional communication system using a multi-hop relay scheme;

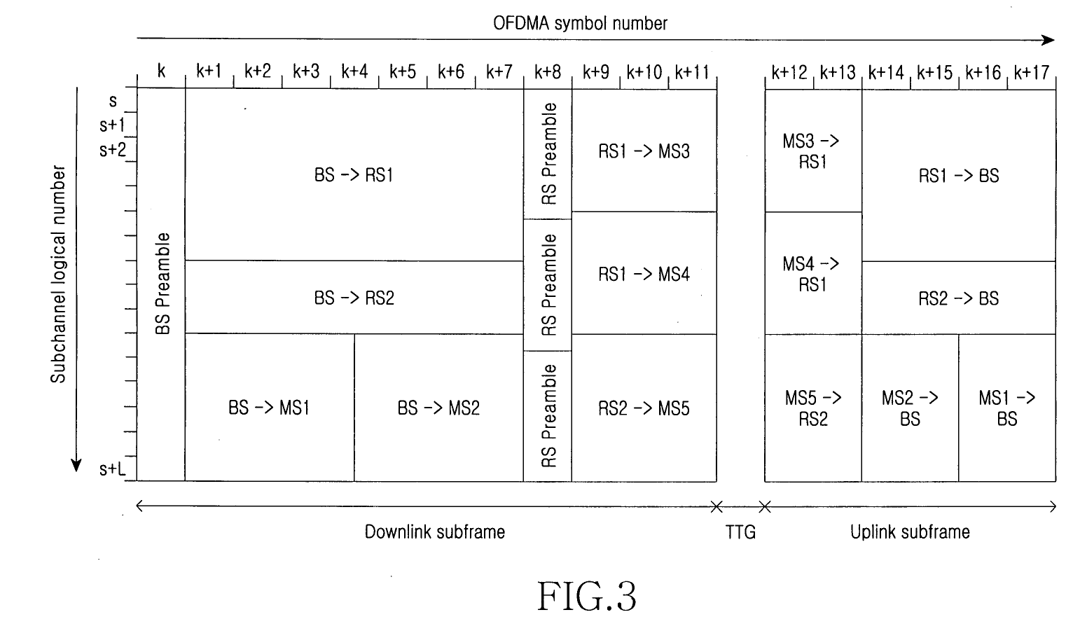

FIG. 3 illustrates a frame structure of a communication system using a multi-hop relay scheme according to the present invention;

FIG. 4 illustrates a structure of an RS preamble according to a first embodiment of the present invention

FIG. 5 illustrates a structure of an RS preamble according to a second embodiment of the present invention

FIG. 6 is a block diagram illustrating the structure of an apparatus for transmitting the RS preamble;

FIG. 7 is a block diagram illustrating the structure of an apparatus for receiving the RS preamble;

FIG. 8 illustrates a table including indexes and MCS levels of the BS-RS link state information values and the received SINR values corresponding to the information values;

FIG. 9 is a view for illustrating a method in which one RS from among multiple RSs searches for an optimum route of another RS adjacent to the RS according to the present invention.

FIGS. 10A and 10B show a flowchart of a process in which an RS generates its own RS preamble; and

FIG. 11 is a flowchart of a process for transmitting link state information to the BS by the MS which has received the RS preamble from the RS according to the above-described process.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted for the sake of clarity and conciseness.

According to the link state report method and system in a communication system of the present invention, at least one RS, which is located around an MS and provides a multi-hop relay route to the MS, reports information of the link state between the RS itself and the MS and the link state between the RS and a BS controlling the RS. Then, the MS recognizes the link state between the RS and the BS and the link state between the MS and the RS, selects an optimum link based on the recognized information, and reports the state information of the selected link to the BS. Further, the MS may select multiple reserved optimum routes having optimum link states and report them to the BS. Then, the BS can select an exact optimum route from the reserved routes, which can minimize the quantity of load in message transmission. Further, according to the present invention, the MS may perform the selection of the optimum route, instead of the BS.

The following description of the present invention is based on a communication system which uses a Time Division Duplex (TDD) scheme and an Orthogonal Frequency Division Multiple Access (OFDMA) scheme. However, the present invention is also applicable to other types of communication systems.

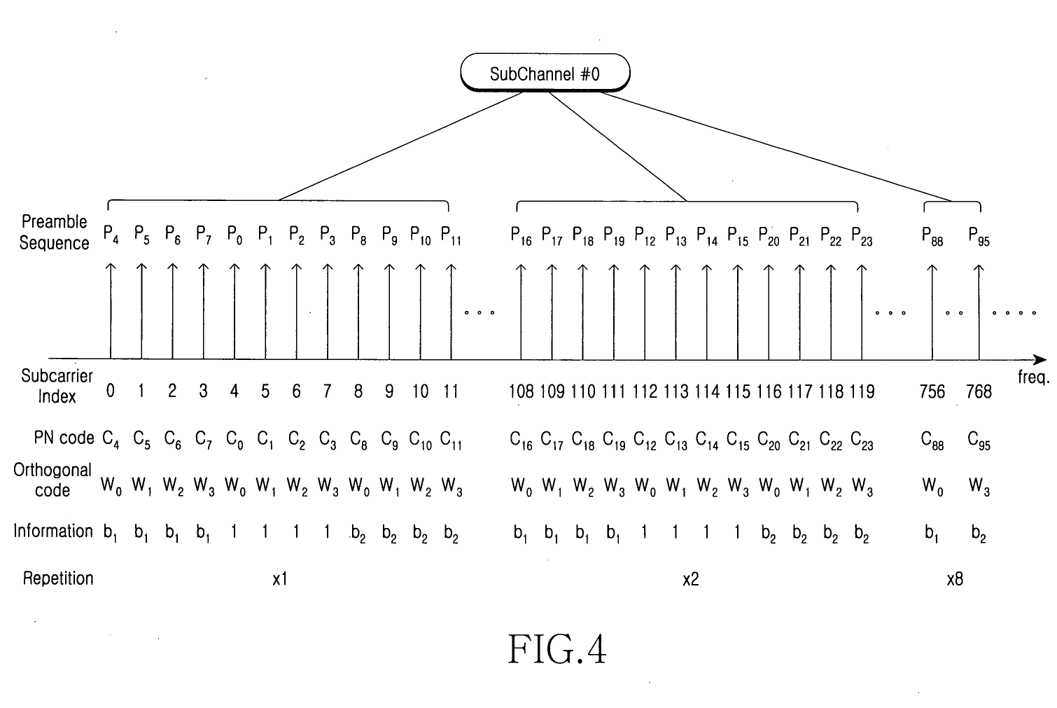

FIG. 3 illustrates a frame structure of an OFDMA/TDD communication system using a multi-hop relay scheme according to the present invention.

Referring to FIG. 3, a frame is divided into an uplink sub-frame and a downlink sub-frame. In each sub-frame, data burst fields are allocated for the link between the BS and the MS (BS→MS1, BS→MS2, MS2→BS, MS1→1 BS). Further, particular frequency-time fields may be allocated for the link between the RS and the MS. In this case, the field for the data bursts transmitted from the RS to the MS (RS1→MS3, RS1→MS4, RS2→MS5) is allocated in the downlink sub-frame, and the field for the data bursts transmitted from the MS to the RS (MS3→RS1, MS4→RS1, MS5→RS2) is allocated in the uplink sub-frame. Also, particular frequency-time fields in the uplink sub-frame may be allocated for transmission of the preambles of the RSs (the RS preambles). In the case of allocation for the transmission of the RS preambles, it is possible to allocate the RSs to different preamble transmission fields. When the preamble of each RS is identified by a specific sequence, multiple RSs (e.g. RS1 & RS2) located within the same cell area can transmit their specific preambles in the same frequency-time field.

In the frame shown in FIG. 3, the entire sub-carrier field within one downlink symbol period is divided into three preamble sub-channels in order to transmit the RS preambles, and each RS transmits a specific preamble sequence in an appointed preamble sub-channel field. If there are many RSs simultaneously performing the relay function, it may be difficult to transmit all the relay data bursts within one frame. Then, the relay data bursts are distributed to several frames by a scheduling algorithm. When each RS transmits a preamble to the MS after such distribution, each of the transmitted preambles includes information of the link state between the RS and the BS as well as the identification information (e.g. identifier) of the RS. Therefore, by successfully receiving the preamble, the MS can recognize the state information of the link between the BS and the RS.

In the communication system using the OFDM scheme as shown in FIG. 3, the beginning of the downlink sub-frame is occupied by a preamble signal including a specific sequence of the BS and enables rapid initial synchronization of the MS. The BS preamble sequence may be a Pseudo Noise (PN) code. When there are a plurality of BSs, the BSs use different PN codes. Further, the PN code of the BS preamble may also be used as a PN code of an RS preamble. Further, when the RS preamble is smaller than the BS preamble, only a portion of the PN code of the BS preamble may be used as the PN code of the RS preamble. By designing the PN code of the RS preamble based on the relation with the PN code of the BS preamble, the MS can identify the BS in relation to the RS when it has received and detected the RS preamble. That is, the RSs located within the same cell use a PN code of the same RS preamble. Further, in order to identify each RS located within the same cell, an orthogonal code may be used. A portion of the orthogonal code is used for the identifier information of each RS, and the other portion of the orthogonal code is used for transfer of the state information of the link between the BS and the RS.

The RS can construct the RS preamble by using a specific sequence, so that the MS having received the RS preamble can recognize the RS which transmitted the RS preamble. The preamble sequence may include a combination of the PN code and the orthogonal code. That is, each sub-carrier used for the preamble carries a value obtained by multiplying a corresponding PN code value by a corresponding orthogonal code value. The preamble sequence Pₙ refers to a data value carried by the n^{th} sub-carrier, wherein n is a logical index having a value within a range from 0 to (N−1), wherein N refers to the length of the preamble sequence. Therefore, the preamble sequence Pₙ is defined by Equation (1) below.
Pₙ=Cₙ×Wᵢ×bⱼ (1)

In Equation (1), Cₙ denotes the n^{th} value of the PN code, Wᵢ denotes the j^{th} value of the orthogonal code allocated to the corresponding RS, and bⱼ denotes the j^{th} value of the information data transmitted by the preamble. When b₀=1, j, which denotes the length of the information data, is defined by Equation (2) below.

$$j = \frac{n}{I} ; 0 \leq j \leq J - 1 \qquad ( 2 )$$

By Equation (2), the relation N=I·J is established. Further, by Equation (1), the first value from among the information data transmitted by the preamble, that is b₀, is set to always be 1, and the preamble sequence Pₙ always has a value of Cₙ×Wᵢ when n has a value within the range from 0 to (N−1). In this relation, because Cₙ is a PN code already acquired during the initial synchronization between the MS and the BS or a portion of the PN code as described above, the value of Cₙ is already known before the detection of the RS preamble. Therefore, the MS can detect the specific orthogonal code of the RS, that is Wᵢ, by using the b₀. Further, the data values from b₁ to bⱼ₋₁ are used to express the state of the link between the BS and the RS. The MS detects Wᵢ by using the reception values of the 0^{th} to (I−1)^{th} sub-carriers, and then restores the data values from b₁ to bⱼ₋₁ by using the Wᵢ, for example, by using the Wᵢ as the pilot tone in channel estimation. If a Quadrature Phase Shift Keying (QPSK) scheme is used for modulation of bⱼ, it is possible to express the state of the link between the BS and the RS in up to 4^{j-1} steps. Further, in order to protect the information data transmitted through bⱼ, it is possible to apply channel coding by using an error correction encoding scheme such as a convolutional coding. In the coding, a repetition coding scheme may be used for rapid restoration at the receiver side of the MS. When a repetition coding scheme with a repetition number of K is used, the information data length j is defined by Equation (3) below.

$$j = \frac{n mod ( J \cdot I )}{I} \qquad ( 3 )$$

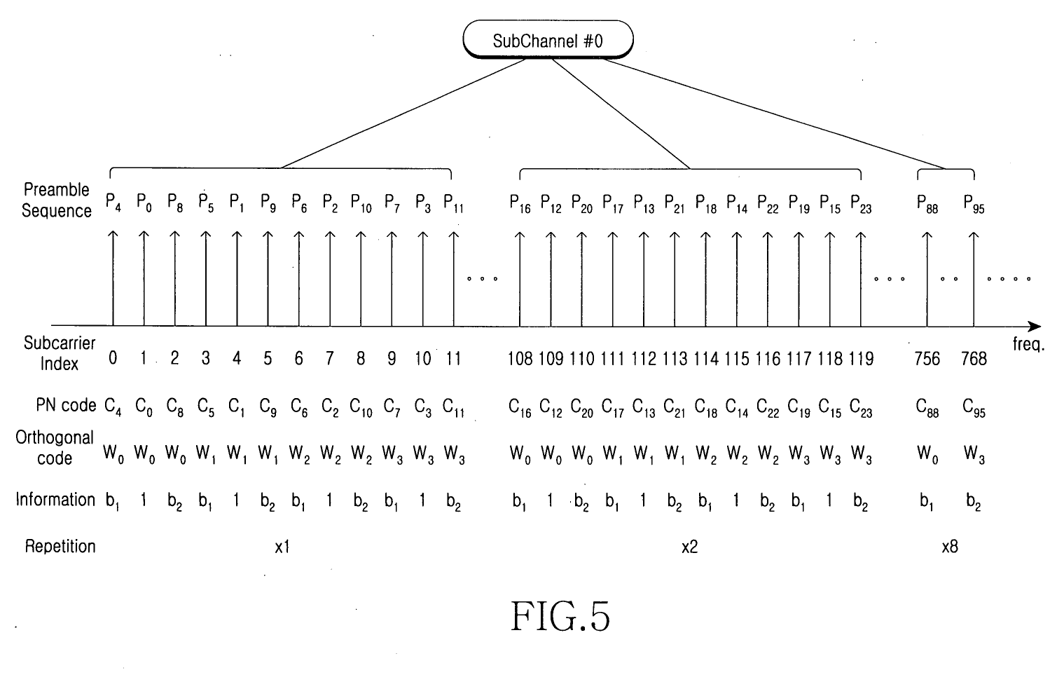

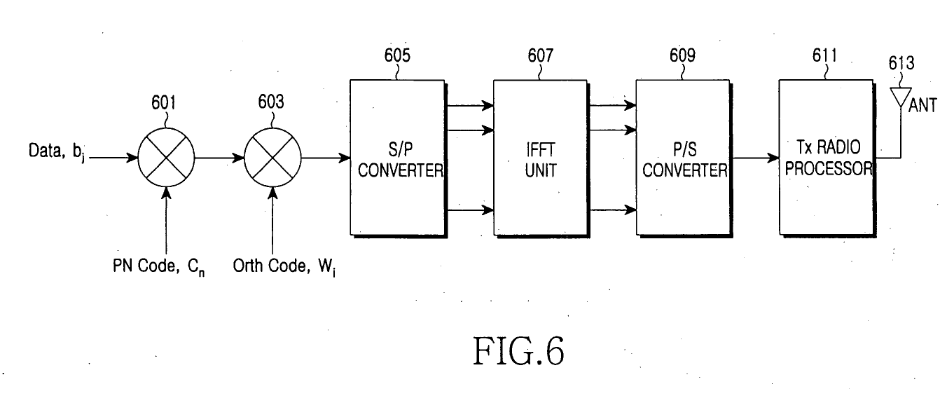

By Equation (3), the relation N=K·I·J is established.
FIGS. 4 and 5 illustrate the structure of an RS preamble sequence to which the repetition coding scheme has been applied.

A Fast Fourier Transform (FFT) unit of the physical channel link considered in FIGS. 4 and 5 has a size of 1024, among which only 864 sub-carriers are used. At this time, if nine sub-channels are used for the RS preamble, each sub-channel includes a total of 96 sub-carriers. The preamble has the following parameters:
N=96, which denotes the length of the RS PN code;
I=4, which denotes the length of the RS orthogonal code;
J=3, which denotes the length of the information data;
K=8, which denotes the number of times of the repetition coding; and
S=9, which denotes the number of the RS preamble sub-channels.
By these parameters, the number of sub-carriers is calculated as S·N=S·K·I·J=864.

Further, the preamble sequence shown in FIG. 4 is mapped to physical sub-carriers, and the preamble sequence shown in FIG. 5 is mapped to adjacent sub-carriers in a crossed scheme. Therefore, in the preamble sequence shown in FIG. 4, the orthogonal codes are adjacent to each other on the frequency plane, so that it is possible to more completely maintain the orthogonality between the orthogonal codes. Meanwhile, the preamble sequence shown in FIG. 5 has a lower orthogonality between the orthogonal codes than that of the preamble sequence shown in FIG. 4. However, the preamble sequence shown in FIG. 5 can better improve the performance of channel estimation in detecting the information data than the preamble sequence shown in FIG. 4. In other words, bo is set to always have a value of 1 (b₀=1), and tones of P₀, P₁, P₂, and P₃, in which the PN codes and the orthogonal codes are transmitted as they are, are used as the pilot tones. Therefore, the preamble sequence shown in FIG. 5 has a better channel estimation performance than the preamble sequence shown in FIG. 4, because the pilot tones are located between the information data.

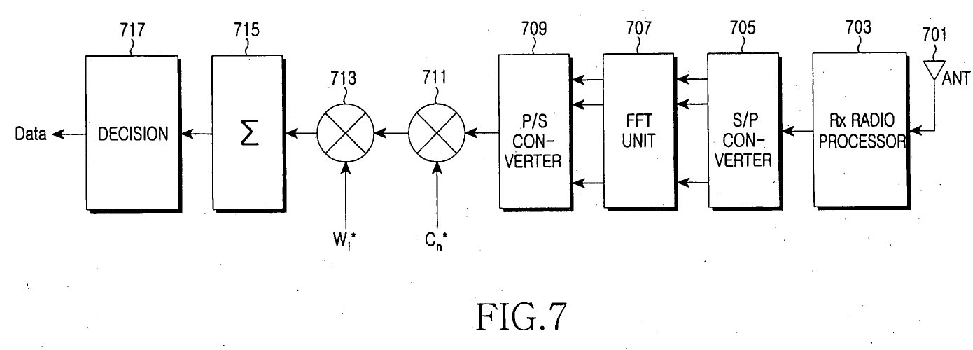

FIG. 6 is a block diagram illustrating the structure of an apparatus for transmitting the RS preamble.

Referring to FIG. 6, the transmitting apparatus includes a first multiplier 601, a second multiplier 603, a serial-to-parallel converter 605, an Inverse Fast Fourier Transform (IFFT) unit 607, a parallel-to-serial converter 609, a transmission radio processor 611, and an antenna 613. The information data bⱼ transmitted through the preamble is multiplied by the PN code Cₙ by the first multiplier 601, and is then multiplied by the orthogonal code Wᵢby the second multiplier 603. The preamble sequence obtained by multiplying the information data bⱼ by the PN code Cₙ and the orthogonal code Wᵢ as described above is converted to parallel data by the serial-to-parallel converter 605, which is then transferred to the IFFT unit 607. The data transformed by the IFFT unit 607 is converted to serial data by the parallel-to-serial converter 609. The serial data is processed by the transmission radio processor 611 and then transmitted through the antenna 613 to the wireless channel. Here, the RS preamble transmitted by the apparatus includes the state information of the link between the BS and the RS as well as the identifier (ID) of the RS.

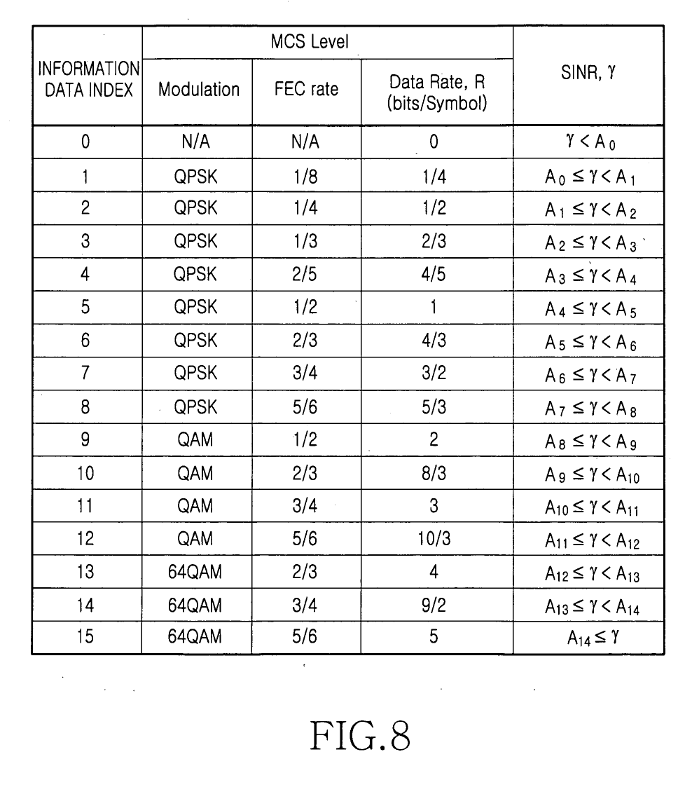

FIG. 7 is a block diagram illustrating the structure of an apparatus for receiving the RS preamble. The following description is based on an assumption that the receiving apparatus of FIG. 7 has detected a corresponding orthogonal code Wᵢ of the RS and has already recognized the orthogonal code Wᵢ.

Referring to FIG. 7, the receiving apparatus includes an antenna 701, a reception radio processor 703, a serial-to-parallel converter 705, a Fast Fourier Transform (FFT) unit 707, a parallel-to-serial converter 709, a first multiplier 711 and a second multiplier 713, a summer 715, and a decision unit 717. The RS preamble received through the antenna 701 is processed by the reception radio processor 703 and is then transferred to the serial-to-parallel converter 705. Then, the data is converted to parallel data by the serial-to-parallel converter 705, and is then Fourier-transformed by the FFT unit 707. Then, the transformed parallel data is converted to serial data by the parallel-to-serial converter 709. The converted serial data is multiplied by a conjugate value Pₙ* of the PN code by the first multiplier 711 and is multiplied by a conjugate value Wᵢ* of the orthogonal code by the second multiplier 713. The data obtained through the multiplication by the conjugate values Pₙ* and Wᵢ* is summed as many times as the number corresponding to the length of the orthogonal code Wᵢ* by the summer 715. Based on the value output from the summer 715, the decision unit 717 restores the information data bⱼ.

As described above, the receiving apparatus can detect the RS preamble transmitted through the wireless channel and restore the information data included in the RS preamble through Equations (4) and (5) below.

Yⱼ defined by Equation (4) below refers to a value obtained by summing products during one orthogonal code length I, wherein each of the products is obtained by multiplying a received value of each sub-carrier by the conjugate values Pₙ* and Wᵢ* of the PN code and orthogonal code by the first multiplier 711 and the second multiplier 713, in order to restore the information data bⱼ by the receiving apparatus.

$$\begin{matrix}{Y}_{j} = {\sum }_{n = jI}^{jI + l - 1} ( {P}_{n} ⨯ {H}_{n} ) \cdot ( {C}_{n}^{*} ⨯ {W}_{i}^{*} ) \\ = {\sum }_{n - jI}^{jI + I - 1} ( {C}_{n} ⨯ {W}_{i} ⨯ {b}_{j} ⨯ {H}_{n} ) \cdot ( {C}_{n}^{*} ⨯ {W}_{i}^{*} ) \\ = {b}_{j} {\sum }_{n = jI}^{jI + I - 1} {H}_{n}\end{matrix} \qquad ( 4 )$$

In Equation (4), Hₙ represents the channel response characteristic of the n^{th} sub-carrier. For convenience of description, the Additive White Gaussian Noise is not considered and the repetition coding is not applied in Equation (4). Because

$${b}_{0} = 1 , {Y}_{0} = {\sum }_{n = 0}^{I - 1} {H}_{n} .$$

Therefore, when corresponding sub-carriers are located adjacent to each other in the frequency domain, it is possible to assume that

$${\sum }_{n = 0}^{l - 1} {H}_{n} \approx {\sum }_{n = jl}^{jI + l - 1} {H}_{n} .$$

Based on such an assumption, it is possible to restore bⱼ as shown in Equation (5) below.

$${Z}_{j} = \frac{{Y}_{j}}{{Y}_{0}} = \frac{{b}_{j} {\sum }_{n = jI}^{jI + I - 1} {H}_{n}}{{\sum }_{n = 0}^{I - 1} {H}_{n}} \approx {b}_{j} \qquad ( 5 )$$

In order to insert the ID of the RS and the state information of the link between the BS and the RS into the RS preamble, the RS preamble is constructed by the combination of the PN code of the BS preamble and the orthogonal code for identification of the RS. In addition to the combination of the PN code and the orthogonal code, another specific code may be applied to the RS preamble. For example, a Generalized Chirp Like (GCL) code may be applied or all RSs may use the same code while each RS is identified by a sub-channel of the RS preamble used by the RS. Further, though the spread/de-spread scheme has been described as a scheme for inserting the information data bⱼ into the RS preamble, it is possible to use another scheme for insertion of the information data bⱼ into the RS preamble. For example, it is possible to user code grouping in the orthogonal code generating tree, wherein mother codes are used for identification of the RSs and child codes are used for transmission of information data bⱼ.

Instead of inserting the state information of the link between the BS and the RS into the transmitted RS preamble as described above, it is possible to insert the state information of the link between the BS and the RS, that is, the information data bⱼ, into a Medium Access control (MAC) message and then broadcast the MAC message. A detailed description about the process for inserting the information data bⱼ into the MAC message and then broadcasting the MAC message is omitted here. Further, although the above description discusses an OFDMA communication system in which the link state information is recognized from the received preamble, the present invention can be applied to all communication systems which recognize the link state by detecting physical channels from pilot tones as well as the preamble.

Hereinafter, a method for determining the state information values (for example, data values of b₁ and b₂) of the BS-RS link by the RS and a method for receiving the state information values of the BS-RS link and reporting the values to the BS through the RS preamble by the MS will be described for a case where a two-hop relay route is provided to the MS and a case where a relay route of three or more hops is provided to the MS.

First, a method for determining the state information values to be inserted in the RS preamble by the RS when a two-hop relay route is provided to the MS will be described.

The RS measures the intensity of the received signals by using the BS preamble or BS pilot tone signals received from the BS and predicts a Signal to Interference and Noise Ratio (SINR) value or a Received Signal Strength Indicator (RSSI) value based on the measured intensity. Then, the RS reports the predicted channel state value to the BS through the uplink. Further, in order to determine the BS-RS link state information value to be transmitted through the RS preamble of the RS, the RS determines a Modulation and Coding Scheme (MCS) level value corresponding to the reception SINR or RSSI value of the BS, and selects a BS-RS link state information value corresponding to the MCS level value.

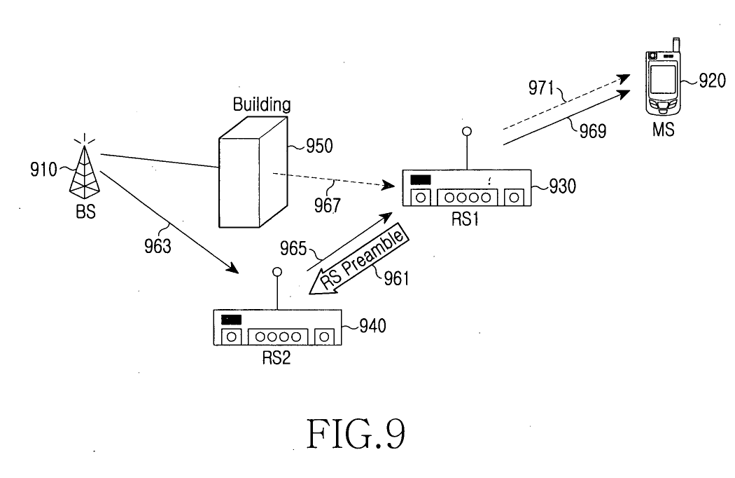

FIG. 8 illustrates a table including indexes and MCS levels of the BS-RS link state information values and the received SINR values corresponding to the information values.

Referring to FIG. 8, the BS-RS link state is divided into sixteen steps, each of which is then given an index. For example, when the length J of the information data is 3 (J=3), it is possible to express 16 step indexes through a combination of data values b₁ and b₂, which are state information values of the BS-RS link, by using the SPSK modulation scheme. In the table, index “0” corresponds to the case where the SINR received from the BS has such a small value that the RS cannot perform the relay function. When the RS receives information of the table as shown in FIG. 8 from the BS, the RS determines an MCS level corresponding to the received SINR level value by using the table. Then, the RS selects an index of the BS-RS link state information value corresponding to the determined MCS level value, determines a link state information value corresponding to the selected index, inserts the determined link state information value into the RS preamble, and then transmits the RS preamble to the MS.

Then, the MS receives the RS preamble and reports the link state information to the BS according to the following process, so that the BS can finally select an optimum route.

By receiving the RS preamble from the RS, the MS can recognize the sub-channel index and the orthogonal code index used by the RS through the detection of the RS preamble. Further, the MS can identify each of the RSs through the combination of the RS preamble sub-channel index and the orthogonal code index. Meanwhile, the MS measures the SINR of the preamble received from the RS, and recognizes the RS-MS link state (i.e. data rate R₂ of the RS-MS link) by using the measured SINR value and the table of FIG. 8. Further, the MS can extract the index of the BS-RS link state information value transmitted through the RS preamble and compares the extracted index with the table of FIG. 8, so that the MS can recognize the data rate R₁ of the BS-RS link. After recognizing the data rate R₂ of the RS-MS link and the data rate R₁ of the BS-RS link in this scheme, the MS calculates an effective data rate E of the route from the BS through the RS to the MS (BS-RS-MS) by using Equation (6) below.

$$E = \frac{1}{\frac{1}{{R}_{1}} + \frac{1}{{R}_{2}}} \qquad ( 6 )$$

After calculating the effective data rate E by Equation (6), the MS selects an RS having the largest effective data rate E as the RS providing the optimum multi-hop relay route. After selecting the optimum RS, the MS reports the RS preamble sub-channel index and the orthogonal code index corresponding to the ID of the selected RS and the received SINR value of the RS to the BS. Then, the BS finally determines the optimum route based on the information reported by the MS.

When there are multiple RSs which provide the multi-hop relay route, the MS calculates the effective data rate E of the BS-RS-MS route formed by each of the RSs. Then, the MS may select one RS having the largest value from among the effective data rates E as the RS providing the optimum multi-hop relay route. Otherwise, in order to further enhance the reliability of the optimum route selection, the MS may determine reserved optimum RSs, which include the RS having the largest effective data rate E and several RSs having high effective data rates E just below the largest effective data rate E, and report the RS preamble sub-channel index and the orthogonal code index corresponding to the ID of each of the reserved RSs and the received SINR value of the reserved RS to the BS. At this time, the number of the reserved optimum RSs reported to the BS has been determined in advance by the BS, and the BS finally selects and determines an optimum RS for the optimum route from among the reserved RSs reported to the BS. A more detailed description will be given later for the case where a general multi-hop relay route of three or more hops is provided to the MS.

When the BS determines the optimum route, the BS takes not only the received SINR of the RS reported by the MS but also the number of hops in the multi-hop relay route, the relay load of the RS, and the energy remaining in the RS into account. In other words, although the received SINR value may be the most important standard for the selection of the optimum route, other parameters may also become standards for the selection of the optimum route. Therefore, it is more advantageous that the MS reports multiple reserved optimum RSs to the BS than that the MS reports a single optimum RS to the BS. Therefore, the present invention can achieve exact selection and determination of an optimum route while minimizing the message load.

Hereinafter, a method for determining the state information value of the BS-RS link by the RS and a method for receiving and reporting the state information value of the BS-RS link to the BS by the MS, in the case where a general multi-hop relay route of three or more hops is provided to the MS, will be described.

In the case of three or more hops, it is possible to apply the same process as that in the case of two hops to the present invention. That is, each RS calculates the effective data rate E from the information data value and the received SINR of the preambles received from other neighbor RSs by using Equation (6) in the same scheme as that in the case of two hops. Thereafter, each of the RSs selects reserved optimum routes based on an effective data rate of the direct route to the BS and the largest effective data rate from among the effective data rates to the neighbor RSs calculated by using Equation (6).

After selecting the reserved optimum routes, the RS reports the selected reserved optimum routes to the BS. Then, the BS determines an optimum route from among the reserved optimum routes and transmits information of the determined optimum route to the MSs and the RSs. At this time, the process of reporting the information of the reserved optimum routes by the RS and determining the optimum route based on the reported information by the BS may be omitted according to communication systems. However, in the system which performs such a process, the RS instead of the MS selects the optimum route and then reports the selected route to the BS.

Each RS selects an index of the BS-RS link state information value based on the table of FIG. 8 with reference to the largest effective data rate. Then, the RS determines a link state information value corresponding to the selected information value index, inserts the determined information value into an RS preamble, and then transmits the RS preamble to the MS or another RS. After the MS receives the RS preamble from each RS, the MS or another RS reports the link state information to the BS as described above, and the BS then finally selects the optimum route.

Even when the number of hops continuously increases, the MS having received the RS preamble or another RS calculates the effective data rate based on the received SINR and the information data value, selects an optimum route to the BS based on the calculated effective data rate, and reports the link state information of the selected route to the BS. Then, the BS finally determines the optimum route based on the reported information and transfers the information about the determined route to the MS or another RS. At this time, the MS or each RS, which calculates the optimum route, need not have a preliminary knowledge about the number of hops included in the optimum route to the RS which provides the hop relay to the MS or each RS. Further, all RSs and MSs report information of reserved optimum routes selected by themselves to the BS, and the BS can thus recognize all the optimum route information of all the RSs and MSs.

Hereinafter, a method for calculating an effective data rate E₃ when RS1 and RS2 provide a 3-hop relay route to the MS will be described. It is assumed that the optimum route from the RS2 to the BS is the BS-RS1-RS2 route. Therefore, the effective data rate E₃ is calculated by Equation (7) below.

$${E}_{3} = \frac{1}{\frac{1}{{R}_{1}} + \frac{1}{{E}_{2}}} = \frac{1}{\frac{1}{{R}_{3}} + \frac{1}{{R}_{2}} + \frac{1}{{R}_{1}}} \qquad ( 7 )$$

In Equation (7), R₁ denotes the data rate of the BS-RS1 link, R₂ denotes the data rate of the BS-RS2 link, and R₃ denotes the data rate of the RS2-MS link. Further, E₂ denotes an effective data rate of an optimum route from the RS2, and E₃ denotes an effective data rate of the BS-RS1-RS2-MS from the MS.

The MS can recognize R₃ from the SINR value of the received RS2 preamble and E₂ from the information data value included in the received RS2 preamble. E₂ is a value included in the transmitted RS preamble of the RS2 and can be defmed by Equation (8) below, based on Equation (6).

$${E}_{2} = \frac{1}{\frac{1}{{R}_{1}} + \frac{1}{{R}_{2}}} \qquad ( 8 )$$

In this manner, the MS can calculate the effective data rate of the multi-hop relay route including three hops. Therefore, the MS can select an optimum multi-hop route including the 3-hop relay route or reserved optimum routes. Then, the MS reports the link state information of the selected routes to the BS, and the BS determines the final optimum route based on the reported information.

According to the present invention, from among multiple RSs, one RS may detect a preamble of another RS adjacent to the RS and can search for not only its own optimum route but also an optimum route of the adjacent RS.

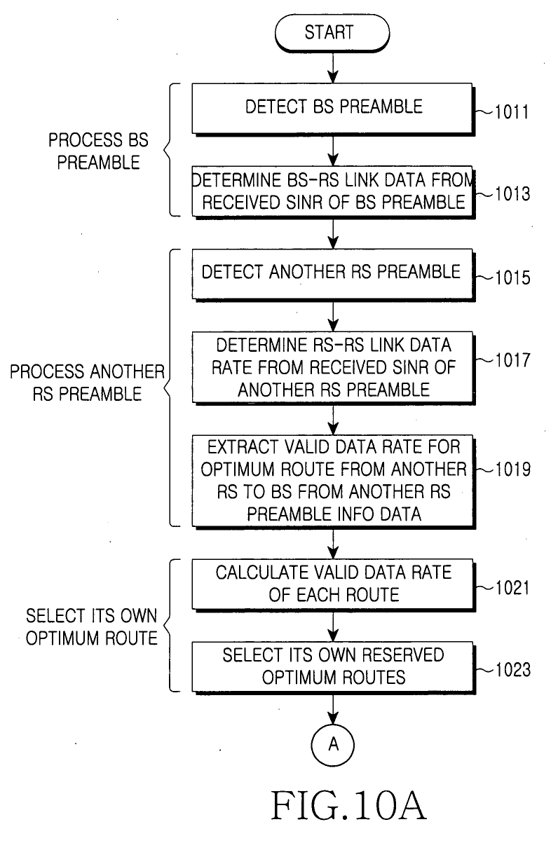

When one RS among multiple RSs has received a preamble of another RS adjacent to the RS, the RS can recognize the optimum route of the adjacent RS (i.e. the link state from the adjacent RS to the BS). The RS calculates an effective data rate of an optimum route to the adjacent RS, which the RS has selected, and reports to the BS the fact that not the adjacent RS but the RS itself is the optimum RS, when the calculated effective data rate value is larger than the effective data rate value received through the RS preamble of the adjacent RS. A more detailed description will be given with reference to FIG. 9.

FIG. 9 is a view for illustrating a method in which one RS from among multiple RSs searches for an optimum route of another RS adjacent to the RS according to the present invention. It is assumed that, at the initial stage, the optimum route between the RS1 930 and the BS 910 is the direct link 967 between them, and the optimum route between the MS 920 and the BS 910 is the 2-hop route 967 and 971 via the RS1 930. Further, the following discussion is based on a situation in which, after the MS 920 is powered on and finishes initial registration in the system, the RS2 940 receives the RS preamble 961 of the RS1 930 in order to search for a new route.

Referring to FIG. 9, the RS2 940 receives an RS preamble 961 from the RS 1930, calculates the effective data rate between the RS2 940 and the RS1 930, and compares the calculated effective data rate with the data rate between the RS2 and the BS 910, so that the RS2 940 recognizes that its own optimum route is the direct route 963 between the RS2 and the BS 910. Further, the RS2 940 calculates the effective data rate of the BS-RS2-RS1 route 963 and 965, and compares the calculated effective data rate with the effective data rate of the optimum route of the RS1 930, which is received through the RS preamble 961, that is, the effective data rate of the BS-RS1 route 967. Through the comparison, the RS2 940 recognizes that the effective data rate of the BS-RS2-RS1 route 963 and 965 is larger than the effective data rate of the BS-RS1 route 967.

Therefore, the RS2 940 reports to the BS 910 the information that the optimum route of the RS2 940 is the direct route 963 with the BS 910 and the optimum route of the RS1 930 is the BS-RS2-RS1 route 963 and 965 which includes the BS2. After receiving the report, the BS 910 re-determines the BS-RS2-RS1 route 963 and 965 as the optimum route of the RS1 930. Further, the BS 910 re-determines the BS-RS2-RS1-MS route 963, 965, and 969 as the optimum route of the MS connected to the RS1 930.

Hereinafter, the operations of the RS and the MS for reporting the link state according to the present invention will be described.

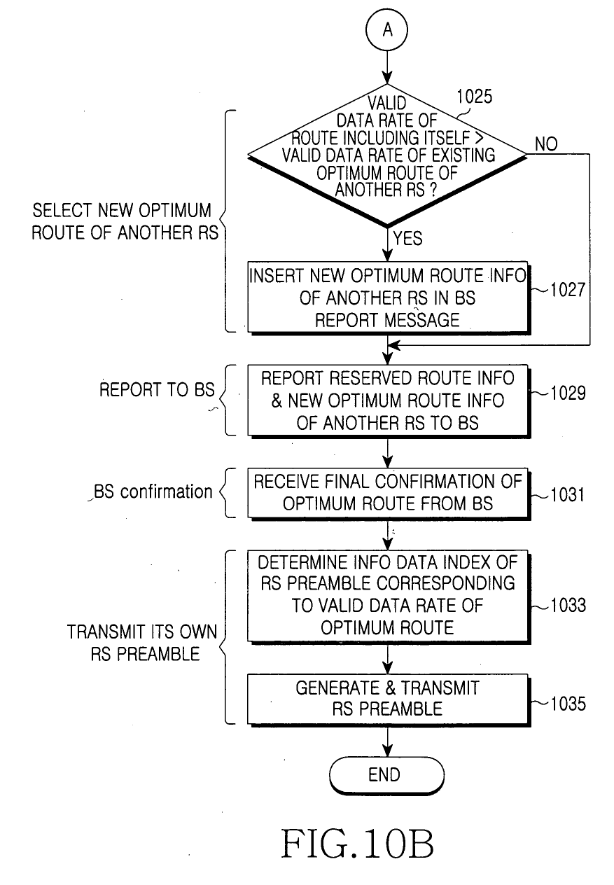

FIGS. 10A and 10B show a flowchart of a process in which an RS generates its own RS preamble.

Referring to FIGS. 10A and 10B, in steps 1011 and 1013, the RS processes a BS preamble. Specifically, the RS detects the BS preamble received from the BS in step 1011, and determines the data rate of the link between the RS itself and the BS based on the received SINR of the BS preamble in step 1013. Then, the RS processes other RS preambles in steps 1015 to 1019. The RS detects other RS preambles from other RSs adjacent to the RS in step 1015, and determines the data rates of the link between the RS itself and the other RSs based on the received SINRs of the other RS preambles in step 1017. Then, in step 1019, the RS extracts effective data rates of optimum routes between the other RSs and the BS from the information data values included in the other RS preambles. At this time, the RS can perform the BS preamble processing steps (step 1011 to 1013) and the RS preamble processing steps (step 1015 to 1019) either simultaneously or in an exchanged order.

Thereafter, the RS selects its own optimum route in steps 1021 to 1023. The RS calculates the effective data rate of each route in step 1021, and then selects reserved optimum routes for the RS itself based on the calculated effective data rates in step 1023.

Thereafter, the RS selects a new optimum route of another RS adjacent to the RS in steps 1025 to 1027. In step 1025, the RS calculates an effective data rate of a new route from the BS to the adjacent RS (BS-another RS) based on the optimum route of the RS itself tentatively selected in step 1023, and compares the calculated effective data rate with an existing optimum route effective data rate of the adjacent RS. That is to say, the RS compares the effective data rate of the new route from the BS through the RS itself to the adjacent RS with the existing optimum route effective data rate of the adjacent RS. As a result of the comparison, when the new optimum route effective data rate of the adjacent RS is larger than the existing optimum route effective data rate of the adjacent RS, the RS inserts information of the newly determined optimum route of the adjacent RS into a BS report message to be sent to the BS in step 1027 and then proceeds to step 1029. If, in step 1025, the new optimum route effective data rate of the adjacent RS is not larger than the existing optimum route effective data rate of the adjacent RS, the RS proceeds to step 1029.

In step 1029, the RS reports information about the reserved optimum routes selected in step 1023 (e.g. RS sub-channel index, orthogonal code index, received SINR, etc.) to the BS. According to the result of comparison in step 1025, the BS report message sent to the BS may further include new optimum route information of another RS. In step 1031, the RS receives the optimum route finally determined by the BS. As described above, step 1031 may be omitted according to the system environments.

Thereafter, in steps 1033 and 1035, the RS generates and transmits its own RS preamble. In step 1033, the RS determines an information data index of an RS preamble corresponding to the effective data rate of the optimum route which the RS has received from the BS. Then, in step 1035, the RS generates an RS preamble including the information data index and then broadcasts the RS preamble through a wireless channel.

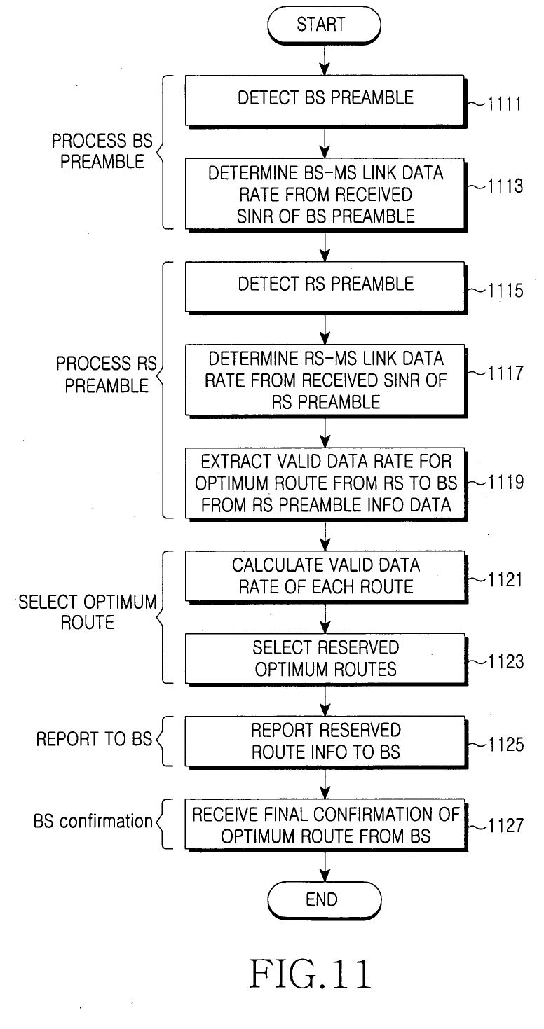

FIG. 11 is a flowchart of a process for transmitting link state information to the BS by the MS which has received the RS preamble from the RS according to the above-described process. The process shown in FIG. 11 is based on an assumption that the MS does not perform the relay function, that is, the MS does not provide the multi-hop relay route. Therefore, the MS performs the same operation as the above-described operation of the RS, except for steps 1025 to 1027 for selection of the new optimum route of another adjacent RS and steps 1033 to 1035 for generation and transmission of the RS preamble of the RS itself in FIGS. 10A and 10B.

Referring to FIG. 11, in steps 1111 and 1113, the MS processes the BS preamble. Specifically, the MS detects the BS preamble in step 1111 and then determines the data rate of the link between the MS itself and the BS from the received SINR of the BS preamble in step 1113. Then, the MS processes the RS preamble in step 1115 to 1119. The MS detects RS preambles from the RSs in step 1115, and determines the data rate of the link between the MS and an RS from the received SINR of the RS preamble in step 1117. Then, in step 1119, the MS extracts an effective data rate of the optimum route between the RS and the MS from the information data value included in the RS preamble.

Thereafter, the MS selects its own optimum route in steps 1121 to 1123. The MS calculates an effective data rate of each route in step 1121 and then selects reserved optimum routes of the MS itself based on the calculated effective data rate in step 1123. In step 1125, the MS reports information about the reserved optimum routes selected in step 1123 (e.g. RS sub-channel index, orthogonal code index, received SINR, etc.) to the BS. In step 1127, the MS receives the finally determined optimum route from the BS. Similar to the operation of the RS described above, step 1127 may be omitted according to the system environments.

The RS transmits its own preamble including an effective data rate of a BS-RS route to the MS, that is, transmits a broadcasting message including the effective data rate to the MS, so that the MS can calculate the effective data rate of the BS-RS-MS route and can select the reserved optimum routes. Therefore, the present invention can achieve exact selection and determination of the optimum route while minimizing the message load.

Also, the BS may report the effective data rate of the optimum route of each RS determined based on the SINRs of RS preambles received from the RSs to all MSs and RSs within the cell by broadcasting. At this time, the RS transmits only its own RS preamble, and the MS or the RS performs effective data rate calculation and optimum route selection in the scheme as described above. That is, the MS having received the RS preamble or another RS calculates the effective data rate of the route to the MS based on a received SINR of the RS preamble and the optimum route effective data rate of a corresponding RS from the BS. Based on the calculated effective data rate, the MS having received the RS preamble or another RS selects reserved optimum routes and reports them to the BS.

The method of the present invention in which the BS transmits an optimum route effective data rate of each RS may be advantageous in the case where each cell includes a small number of RSs. The message broadcasted by the BS, that is, the broadcasting message has a very low error coding rate, because the message must be received by all MSs and RSs within the cell. Therefore, the broadcasting message may be very long in comparison with the quantity of information in the message. Further, the message has an overhead of a MAC header, because it is a message of a MAC layer. Therefore, the more the RSs, the larger the overhead of the message transmitted by the BS. In contrast, the method as described above requires no auxiliary device for transmitting the BS-RS link state information at the RS transmitter/receiver side and the MS receiver side.

According to the present invention, a relay station inserts state information of a link from the relay station to a base station into its own preamble and then reports the preamble to a mobile station. That is, the relay station reports the link state to the mobile station. Then, the mobile station can select reserved optimum routes and report the selected reserved routes to the base station. Therefore, the present invention can achieve exact selection and determination of the optimum route while minimizing the message load.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for reporting a link state by a relay station in a communication system which includes a mobile station, a base station for providing a service to the mobile station, and one or more relay stations for relaying information between the base station and the mobile station, the method comprising the steps of:
(1) detecting a physical channel from the base station and measuring a link state of a link with the base station based on the detected physical channel; and
(2) inserting information of the measured link state into a message and broadcasting the message through a wireless channel.

2. The method as claimed in claim 1, wherein, in step (1), the link state is measured by detecting a base station preamble transmitted from the base station.

3. The method as claimed in claim 2, further including, after step (1):
detecting relay station preambles of neighbor relay stations adjacent to the relay station; and
measuring link states of links with the neighbor base stations based on the detected relay station preambles.

4. The method as claimed in claim 3, wherein the link state is measured by measuring data rates between the relay station and the base station, and between the relay station and neighbor base stations.

5. The method as claimed in claim 4, wherein, in step (2), the information of the measured link state is inserted into a Media Access Control (MAC) message.

6. The method as claimed in claim 4, wherein, in step (2) (2), the information of the measured link state is inserted into a preamble of the relay station.

7. The method as claimed in claim 6, wherein, in step (2), state information of a link having a highest data rate from among the measured data rates is inserted into the preamble of the relay station.

8. The method as claimed in claim 6, wherein, in step (2), state information of more than one link including a link having a highest data rate from among the measured data rates is inserted into the preamble of the relay station.

9. The method as claimed in claim 6, wherein, in step (2), the relay station constructs the preamble of the relay station by using a preamble sequence.

10. The method as claimed in claim 9, wherein the preamble sequence is defined by
Pₙ=Cₙ×Wᵢ×bⱼ,
wherein Cₙ denotes the n^{th} value of a Pseudo Noise (PN) code, Wᵢ denotes the i^{th} value of an orthogonal code allocated to the relay station, and bⱼ denotes the j^{th} value of information data transmitted by the preamble.

11. The method as claimed in claim 10, wherein the orthogonal code includes relay station identification information and link state information.

12. The method as claimed in claim 10, wherein the PN code includes base station identification information.

13. The method as claimed in claim 10, wherein the preamble sequence is mapped to physical sub-carriers in order to construct the preamble of the relay station.

14. The method as claimed in claim 10, wherein the preamble sequence is mapped so that different data is allocated to adjacent sub-carriers in a crossed scheme, in order to construct the preamble of the relay station.

15. A method for reporting a link state by a mobile station in a communication system which includes the mobile station, a base station for providing a service to the mobile station, and one or more relay stations for relaying information between the base station and the mobile station, the method comprising the steps of:
(1) detecting physical channels from the base station and said one or more relay stations and measuring link states of the detected physical channels; and
(2) selecting a physical channel from the detected physical channels based on the measured link states and then broadcasting link state information of the selected physical channel.

16. The method as claimed in claim 15, wherein, in step (1), the physical channels are detected by receiving a base station preamble from the base station and relay station preambles from relay stations.

17. The method as claimed in claim 16, wherein the link state is measured by measuring data rates between the mobile station and the base station and between the mobile station and neighbor base stations.

18. The method as claimed in claim 17, wherein, in step (2), a preamble of a link having a highest data rate from among the measured data rates is selected, allocated to a sub-frame, and then broadcasted.

19. The method as claimed in claim 17, wherein, in step (2), preambles of more than one link including a link having a highest data rate from among the measured data rates are selected, allocated to a sub-frame, and then broadcasted.

20. The method as claimed in claim 16, wherein, in step (2), each of the detected relay station preambles includes a preamble sequence.

21. The method as claimed in claim 20, wherein the preamble sequence is defined by
Pₙ=Cₙ×Wᵢ×bⱼ,
wherein Cₙ denotes the n^{th} value of a Pseudo Noise (PN) code, Wᵢ denotes the i^{th} value of an orthogonal code allocated to the relay station, and bⱼ denotes the j^{th} value of information data transmitted by the preamble.

22. The method as claimed in claim 21, wherein the orthogonal code includes relay station identification information and link state information.

23. The method as claimed in claim 21, wherein the PN code includes base station identification information.

24. The method as claimed in claim 21, wherein the preamble sequence is mapped to physical sub-carriers in order to construct the preamble of the relay station.

25. The method as claimed in claim 21, wherein the preamble sequence is mapped so that different data is allocated to adjacent sub-carriers in a crossed scheme, in order to construct the preamble of the relay station.

26. A system for reporting a link state in a communication system which includes a mobile station, a base station for providing a service to the mobile station, and one or more relay stations for relaying information between the base station and the mobile station, the system comprising:
a transmitter for detecting a base station preamble from the base station and one or more relay station preambles from said one or more relay stations, measuring link states based on the detected preambles, selecting one preamble from the detected preambles based on the measured link states, and broadcasting the selected preamble; and
a receiver for detecting the preamble from the transmitter, measuring a link state based on the detected preamble, and restoring information data transferred by the preamble.

27. The system as claimed in claim 26, wherein the transmitter comprises:
a first multiplier for multiplying data to be transmitted through the preamble by Pseudo Noise (PN) codes; and
a second multiplier for multiplying the data, which has been transmitted by the PN codes, by orthogonal codes, thereby outputting a preamble sequence.

28. The system as claimed in claim 27, wherein the PN code includes base station identification information.

29. The system as claimed in claim 27, wherein the orthogonal code includes relay station identification information and link state information.

30. The system as claimed in claim 27, wherein the transmitter comprises:
a serial-to-parallel converter for converting the preamble sequence to parallel data;
an Inverse Fast Fourier Transform (IFFT) unit for performing IFFT on the parallel data;
a parallel-to-serial converter for converting the Fourier transformed data to serial data; and
a radio processor for broadcasting the serial data through a wireless channel.

31. The system as claimed in claim 26, wherein the receiver comprises:
a first multiplier for multiplying data to be transmitted through the preamble by a conjugate value of Pseudo Noise (PN) codes; and
a second multiplier for multiplying the data, which has been transmitted by the PN codes, by conjugate values of orthogonal codes, thereby outputting a preamble sequence.

32. The system as claimed in claim 31, wherein the receiver further comprises an adder for adding output data of the second multiplier during a length of the orthogonal codes, thereby restoring the data transferred through the preamble.

33. A system for reporting a link state in a communication system which includes a mobile station, a base station for providing a service to the mobile station, and one or more relay stations for relaying information between the base station and the mobile station, the system comprising:
a relay station for detecting a physical channel from the base station, measuring a link state of a link with the base station based on the detected physical channel, inserting information of the measured link state into a message, and broadcasting the message through a wireless channel.

34. The system as claimed in claim 33, wherein the relay station measures the link state by detecting a base station preamble transmitted from the base station.

35. The system as claimed in claim 34, wherein the relay station detects relay station preambles of neighbor relay stations adjacent to the relay station, and measures link states of links with the neighbor base stations based on the detected relay station preambles.

36. The system as claimed in claim 35, wherein the relay station measures the link state by measuring data rates between the relay'station and the base station and between the relay station and neighbor base stations.

37. The system as claimed in claim 36, wherein the relay station inserts information of the measured link state into a Media Access Control (MAC) message.

38. The system as claimed in claim 36, wherein the relay station inserts information of the measured link state into a preamble of the relay station.

39. The system as claimed in claim 38, wherein the relay station inserts state information of a link having a highest data rate from among the measured data rates into the preamble of the relay station.

40. The system as claimed in claim 38, wherein the relay station inserts state information of more than one link including a link having a highest data rate from among the measured data rates into the preamble of the relay station.

41. The system as claimed in claim 38, wherein the relay station constructs the preamble of the relay station by using a preamble sequence.

42. The system as claimed in claim 41, wherein the preamble sequence is defined by
Pₙ=Cₙ×Wᵢ×bⱼ,
wherein Cₙ denotes the n^{th} value of a Pseudo Noise (PN) code, Wᵢ denotes the i^{th} value of an orthogonal code allocated to the relay station, and bⱼ denotes the j^{th} value of information data transmitted by the preamble.

43. The system as claimed in claim 42, wherein the orthogonal code includes relay station identification information and link state information.

44. The system as claimed in claim 42, wherein the PN code includes base station identification information.

45. The system as claimed in claim 42, wherein the relay station maps the preamble sequence to physical sub-carriers in order to construct the preamble of the relay station.

46. The system as claimed in claim 42, wherein the relay station maps the preamble sequence so that different data is allocated to adjacent sub-carriers in a crossed scheme, in order to construct the preamble of the relay station.

47. A system for reporting a link state in a communication system which includes the mobile station, a base station for providing a service to the mobile station, and one or more relay stations for relaying information between the base station and the mobile station, the system comprising:
the mobile station for detecting physical channels from the base station and said one or more relay stations, measuring link states of the detected physical channels, selecting a physical channel from the detected physical channels based on the measured link states, and then broadcasting link state information of the selected physical channel.

48. The system as claimed in claim 47, wherein the mobile station detects a base station preamble from the base station and relay station preambles from relay stations.

49. The system as claimed in claim 48, wherein the mobile station measures the link state by measuring data rates between the mobile station and the base station and between the mobile station and neighbor base stations.

50. The system as claimed in claim 49, wherein the mobile station selects a preamble of a link having a highest data rate from among the measured data rates, allocates the selected preamble to a sub-frame, and then broadcasts the allocated preamble.

51. The system as claimed in claim 49, wherein the mobile station selects preambles of more than one link including a link having a highest data rate from among the measured data rates, allocates the preambles to a sub-frame, and then broadcasts the allocated preambles.

52. The system as claimed in claim 48, wherein the mobile station detects relay station preambles, each of which includes a preamble sequence.

53. The system as claimed in claim 52, wherein the preamble sequence is defined by
Pₙ=Cₙ×Wᵢ×bⱼ,
wherein Cₙ denotes the n^{th} value of a Pseudo Noise (PN) code, Wᵢ denotes the i^{th} value of an orthogonal code allocated to the relay station, and bⱼ denotes the j^{th} value of information data transmitted by the preamble.

54. The system as claimed in claim 53, wherein the orthogonal code includes relay station identification information and link state information.

55. The system as claimed in claim 53, wherein the PN code includes base station identification information.

56. The system as claimed in claim 53, wherein the preamble sequence is mapped to physical sub-carriers in order to construct the preamble of the relay station.

57. The system as claimed in claim 53, wherein the preamble sequence is mapped so that different data is allocated to adjacent sub-carriers in a crossed scheme, in order to construct the preamble of the relay station.
